(19) United States
(12) Patent Application Publication
(10) Pub. No.: US 2005/0080787 A1
(43) Pub. Date: Apr. 14, 2005

(54) System and method for protecting management records

(75) Inventor: Philip M. Ramirez, Charlotte, NC (US)

Correspondence Address: Alexander D. Forman;ICE MILLER, One American Square, Box 82001, Indianapolis, IN, 46282-0002, US

(73) Assignee: National Gypsum Properties, LLC

(21) Appl. No.: 10/748,080

(22) Filed: Dec. 30, 2003

Related U.S. Application Data
(60) Provisional application No. 60/511,013, filed on Oct. 14, 2003.

(51) Int. Cl. G06F 17/30

(52) U.S. Cl. 707/10

(57) ABSTRACT

A computer readable medium for the management, classification and protection of electronic documents and/or records is provided. The computer readable medium includes logic for classification of the record at a remote computer, logic for filing the record at a central database after the classification of the record; and logic for deleting the record from the remote database without user intervention upon the filing of the record at the central database.

### CROSS-REFERENCE TO RELATED APPPLICATIONS

This application claims priority to copending U.S. provisional application entitled “System and Method for Protecting Management Software,” having Ser. No. 60/511,013, filed Oct. 14, 2003, which is entirely incorporated herein by reference.

### INCORPORATION OF COMPUTER PROGRAM LISTING APPENDIX

This application includes a computer program listing appendix showing embodiments of the invention. The computer program listing appendix is submitted on one compact disc created on Dec. 30, 2003 and entitled “Computer Program Listing Appendix.” The compact disc includes a first file created on Dec. 30, 2003 and entitled “A First Embodiment.txt” and having 22,528 bytes. The compact disc includes a second file created on Dec. 30, 2003 and entitled “A Second Embodiment.txt” and having 57,344 bytes. The computer program listing appendix is entirely incorporated herein by reference. Other embodiments of the invention described herein, may be understood by those having ordinary skill in the art without reference to the appendix.

### FIELD OF THE INVENTION

The invention generally relates to protection of records and, more specifically, to system and method for the management, classification, and protection of electronic documents and/or records.

### BACKGROUND

As business organizations grow they generally encounter problems coordinating the electronic output of organizational personnel and systems that may be located at a large number of sites. Additional challenges arise in coordinating or managing that electronic output within the parameters of a Document Retention policy originally designed, or intended for use, for the management and coordination of paper documents and/or records. Various methods of managing electronic documents and/or records generated by the organizational personnel and systems have been attempted but there is room for improvement as it is still common to find that personnel and systems within business organizations are operating without coordination and thus leading to inefficiencies and duplication of efforts and outside the parameters of document retention policies. Business organizations would benefit from a more efficient method of managing, classifying and protecting documents and/or records created throughout the organization with a central database.

### SUMMARY OF THE INVENTION

A computer readable medium for the management, classification and protection of electronic documents and/or records is provided. The computer readable medium includes logic for classification of the record at a remote computer, logic for filing the record at a central database after the classification of the record; and logic for deleting the record from the remote database without user intervention upon the filing of the record at the central database.

Other systems, methods, features, and advantages of the present invention will be, or will become, apparent to one having ordinary skill in the art upon examination of the following drawings and detailed description. It is intended that all such additional systems, methods, features, and advantages be included within this description, be within the scope of the present invention, and be protected by the accompanying claims.

### DESCRIPTION OF THE FIGURES

The invention can be better understood with reference to the following figures. The components in the figures are not necessarily to scale, emphasis instead being placed upon a clearly illustrating the principles of the present invention. Moreover, in the drawings, like reference numerals designate corresponding parts throughout the several views.

FIG. 1 is a block diagram of a computer network including a remote computer, a network, and a central database.

FIG. 2 is a block diagram of remote computer of FIG. 1. The remote computer includes a memory element. The memory element includes an electronic records management classification and protection system.

FIG. 3 shows a flowchart of the electronic records classification portion of an embodiment of the electronic records management, classification and protection system of FIG. 2.

FIG. 4 shows a flowchart of the records filing portion of an embodiment of the electronic records management, classification and protection system of FIG. 2.

FIG. 5 shows a flowchart of a bulk records processing portion of an embodiment of the electronics records management, classification and protection system of FIG. 2.

The following figures form part of the present specification and are included to further demonstrate certain aspects of the present invention. The invention may be better understood by reference to one or more of these figures in combination with the detailed description of specific embodiments presented herein.

### DETAILED DESCRIPTION OF THE INVENTION

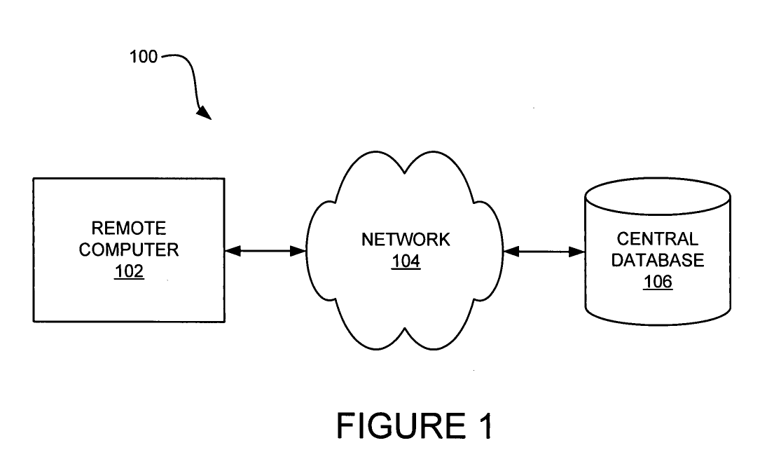

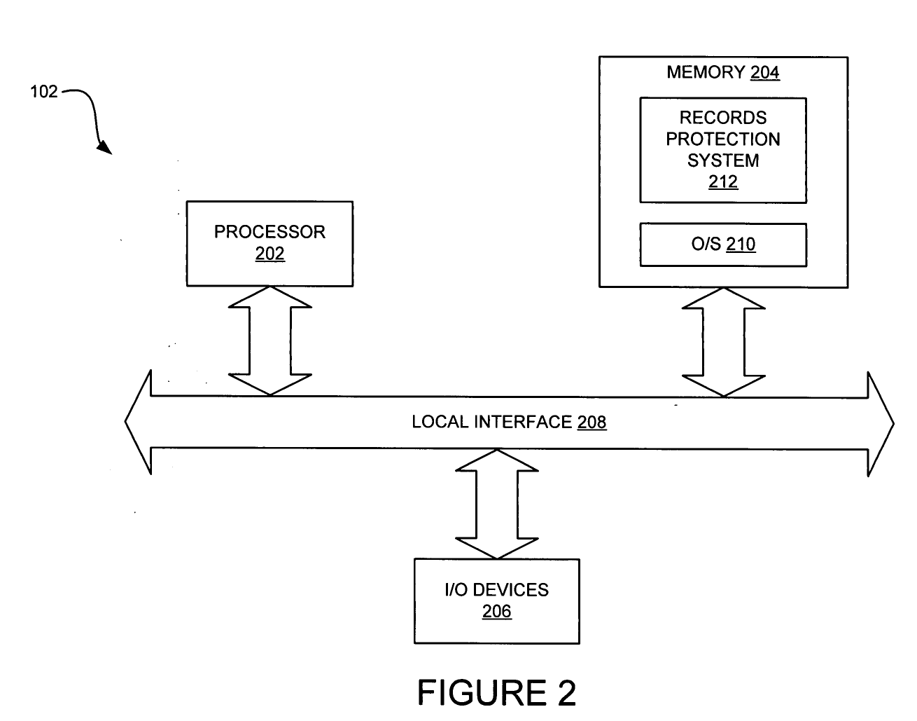

FIG. 1 is a block diagram of a computer network 100 including a remote computer 102, a network 104, and a central database 106. Remote computer 102 and central database 106 may be communicatively coupled through the network via various wired and wireless technologies known in the art. The electronic records management, classification and protection system 212 (FIG. 2) can be implemented in software (e.g., firmware), hardware, or a combination thereof. In one embodiment, the electronic records management, classification and protection system 212 is implemented in software, as an executable program, and is executed by a special or general purpose digital computer, such as a personal computer (PC; IBM-compatible, Apple-compatible, or otherwise), workstation, minicomputer, and a mainframe computer. Remote computer 102 is an example of a general purpose computer that can implement electronic records management, classification and protection system 212.

FIG. 2 is a block diagram of remote computer 102 of FIG. 1. Generally, in terms of hardware architecture, as shown in FIG. 2, the remote computer 102 includes a processor 202, memory 204, and one or more input and/or output (I/O) devices 206 (or peripherals) that are communicatively coupled via a local interface 208. The local interface 208 can be, for example, one or more buses or other wired or wireless connections, as is known in the art. The local interface 208 may have additional elements, which are omitted for simplicity, such as controllers, buffers (caches), drivers, repeaters, and receivers, to enable communications. Further, local interface 208 may include address, control, and/or data connections to enable appropriate communications among the aforementioned components.

Processor 202 is a hardware device for executing software, particularly software stored in memory 204. Processor 202 can be any custom made or commercially available processor, a central processing unit (CPU), an auxiliary processor among several processors associated with remote computer 102, a semiconductor based microprocessor (in the form of a microchip or chip set), a macroprocessor, or generally any device for executing software instructions. Suitable commercially available microprocessors include: PA-RISC series microprocessors from Hewlett-Packard Company, U.S.A.; 80X86 or Pentium series microprocessors from Intel Corporation, U.S.A.; PowerPC microprocessors from IBM, U.S.A.; Sparc microprocessors from Sun Microsystems, Inc.; and 68XXX series microprocessors from Motorola Corporation, U.S.A.

Memory 204 may include one or more memory elements such as volatile memory elements (e.g., random access memory (RAM, such as DRAM, SRAM, SDRAM, etc.)) and nonvolatile memory elements (e.g., ROM, hard drive, tape, CDROM, etc.). Memory 204 may also incorporate electronic, magnetic, optical, and/or other types of storage media. Memory 204 may have a distributed architecture, where various components are situated remote from one another, but can be accessed by processor 202.

The software in memory 204 may include one or more separate programs, each of which comprises an ordered listing of executable instructions for implementing logical functions. In the example of FIG. 2, the software in memory 204 includes the electronic records management, classification and protection system 212 and a suitable control operating system (O/S) 210. Control operating system 210 may include portions of commercially available operating systems such as: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; and (g) an appliance-based operating system, such as that implemented in handheld computers or personal data assistants (PDAs) (e.g., PalmOS available from Palm Computing, Inc., and Windows CE available from Microsoft Corporation). Control operating system 210 essentially controls the execution of other computer programs and provides scheduling, input-output control, file and data management, memory management, and communication control and related services.

The electronic records management, classification and protection system 212 may be a Visual Basic application installed on a remote computer 102 running a Windows Operating system. The electronic records management, classification and protection system 212 may be compatible with Microsoft Office 2000 and higher Windows applications.

The I/O devices 206 may include input devices, for example but not limited to, a keyboard, a mouse, scanners, microphones, touchscreens, electronics scanners and readers, etc. Furthermore, the I/O devices 206 may also include output devices, for example but not limited to a printer, display, etc. Finally, I/O devices 206 may further include devices that communicate both inputs and outputs, for instance a modulator/demodulator (modem; for accessing another device, system, or network), a radio frequency (RF) or other transceiver, a telephonic interface, a bridge, a router, and network connections, etc.

If the remote computer 102 is a personal computer, the software in memory 204 may further include a basic input output system (BIOS) (not shown in the drawings for simplicity). The BIOS is a set of software routines that initialize and test hardware at startup, start the control operating system 210, and support the transfer of data among the hardware devices. The BIOS may be stored in ROM so that the BIOS can be executed when the programmable logic controller 102 is activated.

When the remote computer 102 is in operation, the processor 202 is configured to execute software stored within the memory 204, to communicate data to and from the memory 204, and to generally control operations of the computer 102 pursuant to the software. The electronic records management, classification and protection system 212 and the control operating system 210, in whole or in part, but typically the latter, are read by the processor 202, perhaps buffered within the processor 202, and then executed.

When the electronic records management, classification and protection system 212 is implemented in software, as is shown in FIG. 2, it should be noted that the electronic records management, classification and protection system 212 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The electronic records management, classification and protection system 212 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires; a portable computer diskette (magnetic); a random access memory (RAM) (electronic); a read-only memory (ROM) (electronic); an erasable programmable read-only memory (EPROM, EEPROM, or Flash memory) (electronic); an optical fiber (optical); and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the electronic records management, classification and protection system 212 is implemented in hardware, the electronic records management, classification and protection system 212 can be implemented with any or a combination of the following technologies, which are each well known in the art: a discrete logic circuit(s) having logic gates for implementing logic functions upon data signals; an application specific integrated circuit (ASIC) having appropriate combinational logic gates; a programmable gate array(s) (PGA); a field programmable gate array (FPGA); etc.

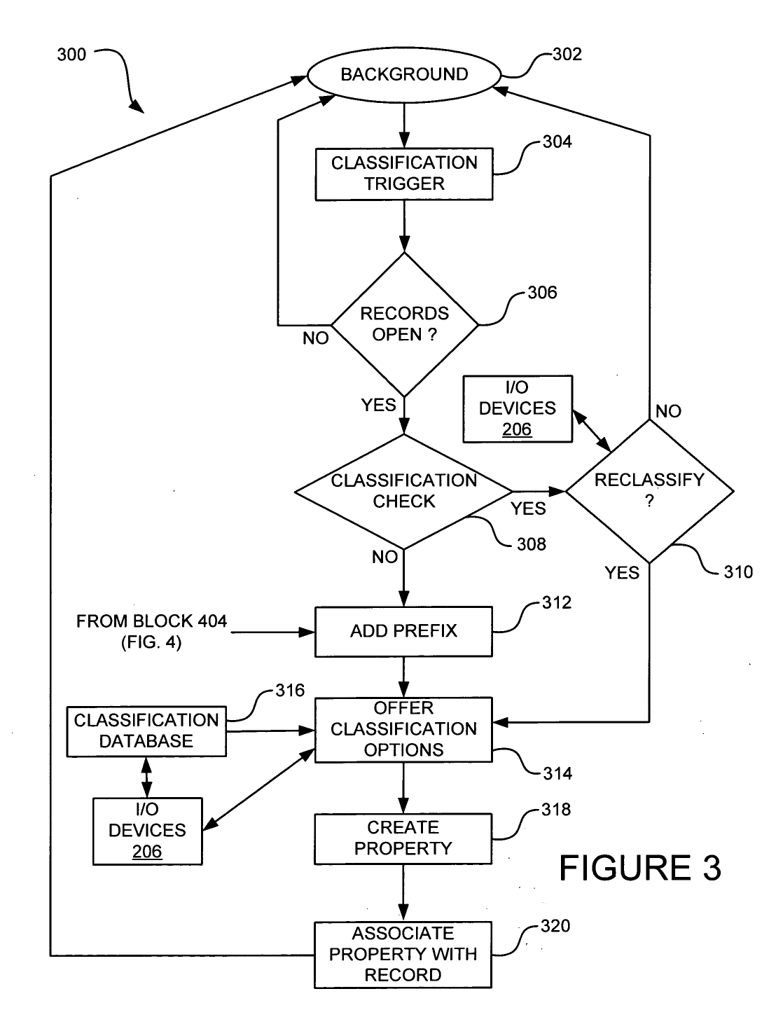

FIG. 3 shows a flowchart 300 of a records classification portion of an embodiment of the electronic records management, classification and protection system 212 of FIG. 2. In block 302, the electronic records management, classification and protection system 212 may remain in the background while the remote computer 102 runs other programs. The other programs may be programs that create records such as, but not limited to, word processors and spreadsheet programs. In block 304, the electronic records management, classification and protection system 212 receives a classification trigger. The classification trigger may be via a mouse click upon an icon. The icon may be labeled “Classify Document.” Other methods of triggering programs may also be employed.

In block 306, the electronic records management, classification and protection system 212 determines whether the remote computer 102 has an open record available for classification. If the remote computer 102 has an open record available for classification, the electronic records management, classification and protection system 212 goes to block 308. If the remote computer 102 does not have an open record available for classification, the electronic records management, classification and protection system 212 returns to block 302.

In block 308, the electronic records management, classification and protection system 212 determines if the record has already been classified by the electronic records management, classification and protection system 212. The electronic records management, classification and protection system 212 may utilize the dsofile.dll in-process Active X component to read and modify the record summary properties. The electronic records management, classification and protection system 212 may avoid using Automation to Microsoft Office. If the record has already been classified then the electronic records management, classification and protection system 212 goes to block 310. In block 310, the electronic records management, classification and protection system 212 provides an inquiry regarding whether the record should be reclassified. I/O devices 206 may be employed to make the inquiry to a user and to receive the user's response. If the inquiry is answered negatively (i.e., no reclassification is desired), the electronic records management, classification and protection system 212 may return to block 302. If the inquiry is answered positively (i.e., a reclassification is desired), the electronic records management, classification and protection system 212 goes to block 314.

In block 308, if the record has not already been classified then the electronic records management, classification and protection system 212 goes to block 312. In block 312, the electronic records management, classification and protection system 212 associates a property prefix file number with the record. In block 312, the electronic records management, classification and protection system 212 provides an inquiry regarding the possible classification choices for the record. I/O devices 206 may be employed to make the inquiry to a user, to coordinate with a classification type database 316, and to receive the user's response. The classification type database 316 may reside at a number of places including at the remote computer 102 and at the central database 106. If located anywhere outside of the central database 106, the classification type database should be coordinated with the central database in order to prevent classifications that are not recognized by the central database 106. If the I/O devices 206 do not indicate the selection of a classification type, the electronic records management, classification and protection system 212 may provide an error message indicating that the selection of a classification system is mandatory. From block 314, the electronic records management, classification and protection system 212 goes to block 318.

In block 318, the electronic records management, classification and protection system 212 creates a document property field. The document property field may include data such as, but not limited to, author identity, document subject, document path, document title, and key search words. In block 320, the document property is attached to the record and the record is saved at the remote computer 102 with the document property. After block 320, the electronic records management, classification and protection system 212 may return to block 302.

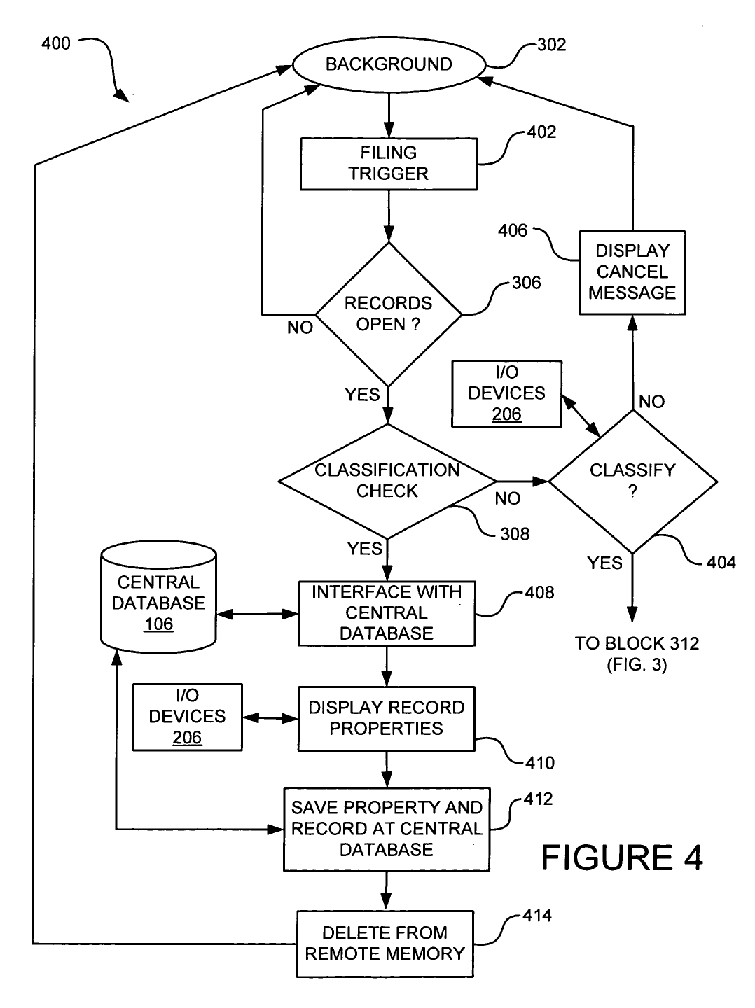

FIG. 4 shows a flowchart 400 of the records filing portion of an embodiment of the electronic records management, classification and protection system 212 of FIG. 2. In block 402, the electronic records management, classification and protection system 212 may remain in the background while the remote computer 102 runs other programs. In block 402, the electronic records management, classification and protection system 212 receives a filing trigger. The filing trigger may be via a mouse click upon an icon. The icon may be labeled “File Document.” Other methods of triggering programs may also be employed.

In block 306, the electronic records management, classification and protection system 212 determines whether the remote computer 102 has an open record available for classification. If the remote computer 102 has an open record available for classification, the electronic records management, classification and protection system 212 goes to block 308. If the remote computer 102 does not have an open record available for classification, the electronic records management, classification and protection system 212 returns to block 302.

In block 308, the electronic records management, classification and protection system 212 determines if the record has already been classified by the electronic records management, classification and protection system 212. If the record has not already been classified then the electronic records management, classification and protection system 212 goes to block 404. In block 404, the electronic records management, classification and protection system 212 provides an inquiry regarding whether the record should be classified. I/O devices 206 may be employed to make the inquiry to a user and to receive the user's response. If the inquiry is answered negatively (i.e., no classification is desired), the electronic records management, classification and protection system 212 may display a “cancel” message in block 406 and return to block 302. If the inquiry is answered positively (i.e., a classification is desired), the electronic records management, classification and protection system 212 goes to block 312 of FIG. 3.

In block 308, if the record has previously been classified, then the electronic records management, classification and protection system 212 goes to block 408. In block 408, the electronic records management, classification and protection system 212 interfaces with the central database 106. After block 408, the electronic records management, classification and protection system 212 goes to block 410.

In block 410, the electronic records management, classification and protection system 212 displays the record properties utilizing the I/O devices 206. After block 410, the electronic records management, classification and protection system 212 goes to block 412. In block 412, the electronic records management, classification and protection system 212 saves record and the associated property field file to the remote database 106. After block 412, the electronic records management, classification and protection system 212 goes to block 414. In block 414, the electronic records management, classification and protection system 212 deletes the record and the associated property field from the remote computer 102. After block 414, the electronic records management, classification and protection system 212 returns to block 302.

The embodiment shown in FIGS. 3 and 4 may be practiced as Microsoft in-process COM servers using the IDTExensibility2 interface. The IDTExensibility2 interface is activated in Microsoft Office through a COM run-time layer. Icons, or other means of triggering the embodiments shown in FIGS. 3 and 4 may be shown when Microsoft Office is opened. The embodiment shown in FIGS. 3 and 4 may use an interface similar to that used by Microsoft Office.

Icons displayed in other programs may trigger portions of the electronic records management, classification and protection system 212. For example, the records classification and records filing portions of the electronic records management, classification and protection system 212 may be triggered using a “Classify Document” and “File Document” icons respectively. The “Classify Document” and “File Document” icons may be displayed as standard toolbar icons upon opening Microsoft Office.

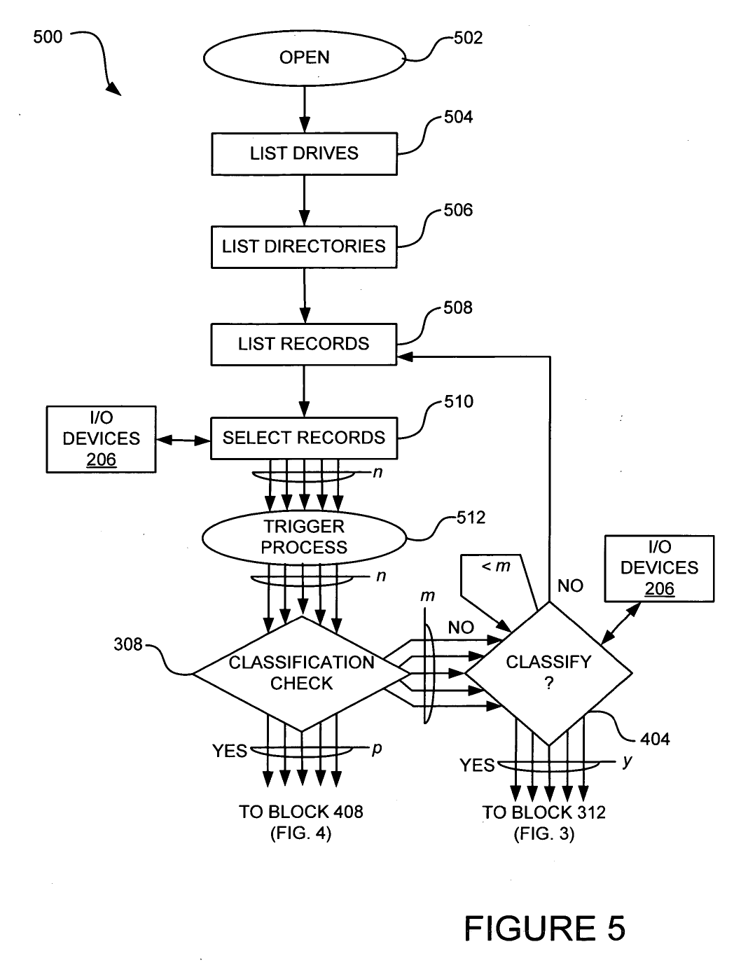

FIG. 5 shows a flowchart 500 of a bulk records processing portion of an embodiment of the electronic records management, classification and protection system 212 of FIG. 2. In block 502, the bulk processing portion of the electronic records management, classification and protection system 212 is opened. In block 504, the electronic records management, classification and protection system 212 lists physical and connected drives connected to remote computer 102.

In block 506, the electronic records management, classification and protection system 212 lists the directories associated with the physical and connected drives. In block 508, the electronic records management, classification and protection system 212 lists records associated with the directories of block 506. In block 510, input/output devices 206 may be used to select one or more records from those listed in block 508. Block 510 may allow records to be opened through common triggering mechanisms such as double clicking on a record with a mouse device or any other input device. Block 510 may also include filtering options for identifying records prior to selection.

In block 512, processing of the one or more records (n records in FIG. 5) is triggered. The triggering may be accomplished via common triggering means such as hitting an icon while the one or more records are highlighted. In block 512, the one or more records are passed to block 308 where the electronic records management, classification and protection system 212 determines if the one or more records have already been classified by the electronic records management, classification and protection system 212. The one or more records that have not been previously classified (m records in FIG. 5) are processed by block 404. The one or more records that have been previously classified (p records in FIG. 5) are processed by block 408 of FIG. 4. In the case of more than one record being passed from FIG. 5 to block 408 (FIG. 4), the electronic records management, classification and protection system 212 may omit block 410 (FIG. 4) and instead assign default properties to the more than one records being passed from FIG. 5 to block 408 (FIG. 4).

In block 404, the electronic records management, classification and protection system 212 provides an inquiry for the m records regarding whether the record should be classified. I/O devices 206 may be employed to make the inquiry to a user and to receive the user's response. A bulk classify option may be offered and selected through I/O devices 206. Alternatively, as the inquiry for records less than m is answered, the electronic records management, classification and protection system 212 may display a “classify next record” message and return to block 404. After the user indicates a classification decision for record m, the electronic records management, classification and protection system 212 may return to a previous block, such as block 508. If the inquiry is answered positively (i.e., a classification is desired for any or all records y), the electronic records management, classification and protection system 212 goes to block 312 of FIG. 3 where records y are classified.

In the case of one or more records p being passed from FIG. 5 to block 408 (FIG. 4) and in the case of one or more records y being passed from FIG. 5 to block 312 (FIG. 3), records p and y being associated with the bulk records processing portion of electronic records management, classification and protection system 212, the electronic records management, classification and protection system 212 may return to block 508 (FIG. 5) rather than returning to background 302.

Flowcharts 300, 400, and 500 of FIGS. 3, 4 and 5 show the architecture, functionality, and operation of a possible implementation of the electronic records management, classification and protection system 212. The blocks represent modules, segments, and/or portions of code. The modules, segments, and/or portions of code include one or more executable instructions for implementing the specified logical function(s). In some implementations, the functions noted in the blocks may occur in a different order than that shown in FIGS. 3, 4 and 5. For example, two blocks shown in succession in FIGS. 3, 4 and 5 may be executed concurrently or the blocks may sometimes be executed in another order, depending upon the functionality involved.

All of the systems and methods disclosed and claimed herein can be made and executed without undue experimentation in light of the present disclosure. It should be emphasized that the above-described embodiments of the present invention, particularly, any “preferred” embodiments, are merely possible examples of implementations, merely setting forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

1. A computer readable medium for the management, classification and protection of electronic documents and/or records, the computer readable medium comprising:
logic for classification of the record at a remote computer;
logic for filing the record at a central database after the classification of the record; and
logic for deleting the record from the remote database without user intervention upon the filing of the record at the central database.

2. The computer readable medium of claim 1, wherein the logic for classification includes logic for determining whether the record is open at the remote computer.

3. The computer readable medium of claim 1, wherein the logic for classification includes logic for determining whether the record has previously been classified.

4. The computer readable medium of claim 1, wherein the logic for classification includes logic for reclassifying a previously classified record.

5. The computer readable medium of claim 1, wherein the logic for classification includes logic for saving the record with an associated property in a memory element of the remote computer.

6. The computer readable medium of claim 1, further including:
logic for selecting a plurality of records;
logic for bulk classification of the plurality of selected records at the remote location.

7. The computer readable medium of claim 1, wherein the logic for filing includes logic for displaying record properties.

8. A method for the management, classification and protection of electronic documents and/or records, the method comprising the steps of:
classifying the record at a remote computer;
filing the record at a central database after the classification of the record; and
deleting the record from the remote database without user intervention upon the filing of the record at the central database.

9. The method of claim 8, wherein the step of classifying the record includes a step of determining whether the record is open at the remote computer.

10. The method of claim 8, wherein the step of classifying the record includes a step of determining whether the record has previously been classified.

11. The method of claim 8, wherein the step of classifying the record includes a step of reclassifying a previously classified record.

12. The method of claim 8, wherein the step of classifying the record includes a step of saving the record with an associated property in a memory element of the remote computer.

13. The method of claim 8, further including the steps of:
selecting a plurality of records;
classifying the plurality of selected records at the remote location.

14. The method of claim 8, wherein the step of filing includes logic for displaying record properties.

15. A system for the management, classification and protection of electronic documents and/or records, the system comprising:
means for classifying the record at a remote computer;
means for filing the record at a central database after the classification of the record; and
means for deleting the record from the remote database without user intervention upon the filing of the record at the central database.

16. The system of claim 15, wherein the means for classifying the record includes means for determining whether the record is open at the remote computer.

17. The system of claim 15, wherein the means for classifying the record includes means for determining whether the record has previously been classified.

18. The system of claim 15, wherein the means for classifying the record includes means for reclassifying a previously classified record.

19. The system of claim 15, wherein the means for classifying the record includes means for saving the record with an associated property in a memory element of the remote computer.

20. The system of claim 15, further including:
means for selecting a plurality of records;
means for classifying the plurality of selected records at the remote location.

21. The system of claim 15, wherein the means for filing includes logic for displaying record properties.
